(19) United States
(12) Patent Application Publication
(10) Pub. No.: US 2024/0217884 A1
(43) Pub. Date: Jul. 4, 2024

(54) Core-shell particle and ceramic bulk

(71) Applicant: INDUSTRIAL TECHNOLOGY RESEARCH INSTITUTE, Hsinchu (TW)

(72) Inventors: Sheng-Min YU, Taoyuan City (TW); Ming-Hui CHANG, Zhudong Township (TW); Yu-Ming CHEN, Taipei City (TW); Tzu-Chi CHOU, Hsinchu City (TW); Ying-Hsuan LEE, Taoyuan City (TW)

(73) Assignee: INDUSTRIAL TECHNOLOGY RESEARCH INSTITUTE, Hsinchu (TW)

(21) Appl. No.: 18/147,803

(22) Filed: Dec. 29, 2022

(51) Int. Cl. C04B 35/581; C04B 35/628; C04B 35/645

(52) U.S. Cl. CPC C04B 35/581; C04B 35/62842; C04B 35/62884; C04B 35/645; C04B 2235/3865; C04B 2235/402; C04B 2235/5436; C04B 2235/5445; C04B 2235/6567

(57) ABSTRACT

A core-shell particle includes a core and a shell that is wrapped around the core. The core includes aluminum nitride. The shell includes aluminum and a dopant, and the dopant is yttrium, calcium, magnesium, lanthanum, niobium, titanium, copper, or a combination thereof. The aluminum and the dopant in the shell have a weight ratio of 90:10 to 99.9:0.1. The core-shell particle can be sintered to form a ceramic bulk.

### TECHNICAL FIELD

The technical field relates to a core-shell particle and a ceramic bulk formed by sintering the core-shell particle.

### BACKGROUND

The global electric vehicle market is expected to reach 9,000,000 units in 2025, and the demand for a key material, aluminum nitride, is continuously increasing. However, the aluminum nitride itself will be hydrolyzed, which generates Al(OH)₃ on the surface of the aluminum nitride powder. As such, sintering defects are formed in the aluminum nitride substrate, which lowers its thermal conductivity. Accordingly, a precursor material for sintering aluminum nitride substrates is called for to overcome this problem with the hydrolysis of aluminum nitride powder.

### SUMMARY

One embodiment of the disclosure provides a core-shell particle, including a core including aluminum nitride; and a shell that is wrapped around the core, wherein the shell includes aluminum and a dopant, and the dopant is yttrium, calcium, magnesium, lanthanum, niobium, titanium, copper, or a combination thereof.

In some embodiments, the core and the shell have a weight ratio of 90:10 to 99:1.

In some embodiments, the core and the shell have a weight ratio of 95:5 to 98:2.

In some embodiments, the aluminum and the dopant in the shell have a weight ratio of 90:10 to 99.9:0.1.

In some embodiments, the aluminum and the dopant in the shell have a weight ratio of 95:5 to 99.5:0.5.

In some embodiment, the shell has a thickness of 5 nm to 100 nm.

In some embodiments, the core has a particle size of 300 nm to 3000 nm.

One embodiment provides a ceramic bulk formed by sintering the described core-shell particle.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a core-shell particle, including a core and a shell. The core may include aluminum nitride. In some embodiments, the aluminum nitride may contain inevitable oxygen, e.g. greater than 0 wt % to 2 wt % of oxygen. If the oxygen amount is too high, the thermal conductivity of the bulk ceramic formed from the core-shell particle will be decreased. However, it should be understood that the pure aluminum nitride without oxygen may serve as the core.

The shell may wrap the core, and the shell includes aluminum and a dopant. In some embodiments, the dopant is yttrium, calcium, magnesium, lanthanum, niobium, titanium, copper, or a combination thereof. Note that not all the elements are suitable for serving as the dopant. For example, if silver or gold is adopted as the dopant, the metal phase will remain in the ceramic formed by sintering the core-shell particle, thereby degrading the insulation property of the ceramic. If lithium, sodium, or potassium is adopted as the dopant, they will be easily evaporated and the ceramic formed by sintering the core-shell particle will have a porosity that is too high, thereby lowering the ceramic structural strength.

In some embodiments, the core has a particle size of 300 nm to 3000 nm. If the particle size of the core is too small, the powder will easily aggregate and difficult to mill. If the particle size of the core is too large, the ceramic bulk formed by sintering the core-shell particle will have a high porosity. In some embodiment, the shell has a thickness of 5 nm to 100 nm. In some embodiments, the core and the shell have a weight ratio of 90:10 to 99:1, such as 95:5 to 98:2. If the shell is too thick (i.e. the amount of the shell is too much), the ceramic bulk formed by sintering the core-shell particle will have an insufficient thermal conductivity. If the shell is too thin (i.e. the amount of the shell is too less), the core-shell particle will be easily hydrolyzed.

In some embodiments, aluminum and the dopant in the shell have a weight ratio of 90:10 to 99.9:0.1, such as 95:5 to 99.5:0.5. If the dopant amount is too low (e.g. no dopant), the ceramic bulk formed by sintering the core-shell particle will have an insufficient density. If the dopant amount is too high, the ceramic bulk formed by sintering the core-shell particle will have an insufficient thermal conductivity.

In some embodiments, the core-shell particle can be formed as described below. It should be understood that the below method is just for illustration, and the disclosure is not limited thereto. One skilled in the art may adopt any suitable method to form the core-shell particles according to requirements, and be not limited to the below method.

Aluminum nitride powder (with a particle size of 300 nm to 3000 nm) is put into a reaction chamber, and then heated to 300° C. to 500° C. In addition, several steel cylinders containing metal acetylacetonate compound powders, such as aluminum acetylacetonate compound powder (e.g. Al(acac)₃) and dopant acetylacetonate compound powder (e.g. Y(acac)₃, Ca(acac)₃, the like, or a combination thereof) are heated to 300° C. to 500° C. to form metal acetylacetonate compound vapors. Nitrogen of different flow rates is introduced to the metal acetylacetonate compound vapors, respectively, and then introduced to the reaction chamber, thereby controlling the ratio of aluminum acetylacetonate compound vapor to dopant acetylacetonate compound vapor introduced into the reaction chamber. The nitrogen introduced into the aluminum acetylacetonate compound vapor has a flow rate of 0.01 L/min to 10 L/min, and the nitrogen introduced into the dopant acetylacetonate compound vapor has a flow rate of 0.01 L/min to 10 L/min. Because the aluminum nitride powder is heated and the mixture gas of the nitrogen and the metal acetylacetonate compound vapors are introduced into the reaction chamber, the aluminum nitride is in a fluid state. As such, the aluminum nitride can be evenly mixed with and in contact with the metal acetylacetonate compound vapors. The metal acetylacetonate compound vapors are mixed and then deposited onto the surface of the aluminum nitride powder, thereby forming a metal acetylacetonate compound film on the surface of the aluminum nitride powder. When the metal acetylacetonate compound film achieves the desired thickness, introducing the mixture gas of nitrogen and the metal acetylacetonate compound vapors into the reaction chamber is stopped, and the temperature of the aluminum nitride powder wrapped in the metal acetylacetonate compound film is kept at 300° C. to 500° C. As such, the acetylacetonate molecule is gradually decomposed to leave a dopant-doped aluminum shell (with a thickness of 5 nm to 100 nm) to wrap the aluminum nitride powder.

One embodiment provides a ceramic bulk formed by sintering the described core-shell particle. The ceramic bulk has a high density (e.g. 3.28 g/cm³ to 3.3 g/cm³), a high thermal conductivity (e.g. 150 W/m·K to 200 W/m·K), and a low porosity. There two problems existing in ceramic bulk formed by sintering conventional aluminum nitride powder. First, the aluminum nitride powder is easily hydrolyzed, such that loose aluminum hydroxide will be formed on the surface of the aluminum nitride powder. The aluminum nitride has an overly high oxygen content and porosity during sintering to form the bulk, and the bulk thus has an insufficient density and low thermal conductivity. Second, the process of sintering the aluminum nitride to form the ceramic bulk needs addition of yttrium oxide, calcium oxide, or a combination thereof to help sintering. However, the yttrium oxide powder and calcium oxide powder are not evenly distributed, such that the ceramic bulk formed by sintering has too much defects and therefore has a low thermal conductivity. Because the shell of the core-shell structure in the disclosure is dopant-doped aluminum, the dopant can be evenly dispersed on the surface of the aluminum nitride powder, and the shell is water resistant to prevent the aluminum nitride from being hydrolyzed as loose aluminum hydroxide. The defects of the sintered ceramic bulk can be decreased due to the evenly distributed dopant.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Comparative Example 1 (AlN)

20 g of aluminum nitride powder (with a particle size of 300 nm to 3000 nm) was dipped into 20 mL of water to measure the pH values of the water after dipping the aluminum nitride powder in water for different periods. The pH value was 8 after dipping the aluminum nitride powder for 2 hours, the pH value was 10 after dipping the aluminum nitride powder for 6 hours, the pH value was 10 after dipping the aluminum nitride powder for 22 hours, and the pH value was 10 after dipping the aluminum nitride powder for 26 hours. Obviously, the aluminum nitride powder was easily hydrolyzed.

20 g of aluminum nitride powder was mixed with 0.6 g of yttrium oxide. The mixture was then put into a mold, and then pressed and heated to 1790° C. for being sintered for 4 hours to form a ceramic bulk with a thermal conductivity of 127 W/m·K. The above steps were repeated, and the difference was heated to 1810° C. for being sintered for 4 hours to form a ceramic bulk with a thermal conductivity of 144 W/m·K.

### Example 1 (AlN/(Al:Y=99.4:0.6))

Aluminum nitride powder (with a particle size of 300 nm to 3000 nm) was put into a reaction chamber, and then heated to 300° C. to 400° C. In addition, several steel cylinders containing metal acetylacetonate compound powders such as Al(acac)₃ and Y(acac)₃ were heated to 300° C. to 400° C. to form metal acetylacetonate compound vapors. Nitrogen of different flow rates was introduced to the metal acetylacetonate compound vapors, respectively, and then introduced to the reaction chamber, thereby controlling the ratio of aluminum acetylacetonate compound vapor to yttrium acetylacetonate compound vapor introduced into the reaction chamber. The nitrogen introduced into the aluminum acetylacetonate compound vapor had a flow rate of 0.1 L/min, and the nitrogen introduced into the yttrium acetylacetonate compound vapor had a flow rate of 0.01 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 300° C. to 400° ° C. As such, the acetylacetonate molecule was gradually decomposed to leave an yttrium-doped aluminum shell (with a thickness of 10 nm to 30 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited yttrium-doped aluminum shell) contained 99.40 wt % of aluminum and 0.60 wt % of yttrium. In the above core-shell particle, the core and the shell had a weight ratio of 90.6:9.4.

20 g of core-shell particle was dipped into 20 mL of water to measure the pH values of the water after dipping the core-shell particle in water for different periods. The pH value was 7 after dipping the core-shell particle for 2 hours, the pH value was 7 after dipping the core-shell particle for 6 hours, the pH value was 8 after dipping the core-shell particle for 22 hours, and the pH value was 9 after dipping the core-shell particle for 26 hours. Obviously, the core-shell particle was less prone to be hydrolyzed compared to the aluminum nitride powder without being wrapped in a shell.

100 g of the described core-shell particle was put into a mold, and then pressed and heated to 1790° ° C. for being sintered for 4 hours to form a ceramic bulk with a thermal conductivity of 167 W/m·K. The above steps were repeated, and the difference was heated to 1810° C. for being sintered for 4 hours to form a ceramic bulk with a thermal conductivity of 172 W/m·K. Obviously, the ceramic bulk formed by sintering the core-shell particle at the same temperature had a higher thermal conductivity compared to the ceramic bulk formed by sintering the aluminum nitride powder without being wrapped in a shell.

### Example 2 (AlN/(Al:Ca=98.8:1.2))

Aluminum nitride powder (with a particle size of 800 nm to 2500 nm) was put into a reaction chamber, and then heated to 350° C. to 385° C. In addition, several steel cylinders containing metal acetylacetonate compound powders such as Al(acac)₃ and Ca(acac)₃ were heated to 300° C. to 400° C. to form metal acetylacetonate compound vapors. Nitrogen of different flow rates was introduced to the metal acetylacetonate compound vapors, respectively, and then introduced to the reaction chamber, thereby controlling the ratio of aluminum acetylacetonate compound vapor to calcium acetylacetonate compound vapor introduced into the reaction chamber. The nitrogen introduced into the aluminum acetylacetonate compound vapor had a flow rate of 0.075 L/min, and the nitrogen introduced into the calcium acetylacetonate compound vapor had a flow rate of 0.025 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 300° ° C. to 400° C. As such, the acetylacetonate molecule was gradually decomposed to leave a calcium-doped aluminum shell (with a thickness of 30 nm to 40 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited calcium-doped aluminum shell) contained 98.8 wt % of aluminum and 1.2 wt % of calcium. In the above core-shell particle, the core and the shell had a weight ratio of 92.2:7.8.

20 g of core-shell particle was dipped into 20 mL of water to measure the pH values of the water after dipping the core-shell particle in water for different periods. The pH value was 7 after dipping the core-shell particle for 2 hours, the pH value was 7 after dipping the core-shell particle for 6 hours, the pH value was 8 after dipping the core-shell particle for 22 hours, and the pH value was 9 after dipping the core-shell particle for 26 hours. Obviously, the core-shell particle was less prone to be hydrolyzed compared to the aluminum nitride powder without being wrapped in a shell.

100 g of the described core-shell particle was put into a mold, and then pressed and heated to 1790° C. for being sintered for 4 hours to form a ceramic bulk with a thermal conductivity of 170 W/m·K. The above steps were repeated, and the difference was heated to 1810° C. for being sintered for 4 hours to form a ceramic bulk with a thermal conductivity of 174 W/m·K. Obviously, the ceramic bulk formed by sintering the core-shell particle at the same temperature had a higher thermal conductivity compared to the ceramic bulk formed by sintering the aluminum nitride powder without being wrapped in a shell.

### Example 3 (AlN/(Al:Y:Ca=98.7:0.5:0.8))

Aluminum nitride powder (with a particle size of 500 nm to 2700 nm) was put into a reaction chamber, and then heated to 350° C. to 385° C. In addition, several steel cylinders containing metal acetylacetonate compound powders such as Al(acac)₃, Y(acac)₃, and Ca(acac)₃ were heated to 350° C. to 400° C. to form metal acetylacetonate compound vapors. Nitrogen of different flow rates was introduced to the metal acetylacetonate compound vapors, respectively, and then introduced to the reaction chamber, thereby controlling the ratio of the aluminum acetylacetonate compound vapor to the yttrium acetylacetonate compound vapor to the calcium acetylacetonate compound vapor introduced into the reaction chamber. The nitrogen introduced into the aluminum acetylacetonate compound vapor had a flow rate of 0.05 L/min, the nitrogen introduced into the yttrium acetylacetonate compound vapor had a flow rate of 0.015 L/min, and the nitrogen introduced into the calcium acetylacetonate compound vapor had a flow rate of 0.015 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 300° C. to 400° C. As such, the acetylacetonate molecule was gradually decomposed to leave an yttrium and calcium-doped aluminum shell (with a thickness of 10 nm to 30 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited yttrium and calcium-doped aluminum shell) contained 98.7 wt % of aluminum, 0.5 wt % of yttrium, and 0.8 wt % of calcium. In the above core-shell particle, the core and the shell had a weight ratio of 95.1:4.9.

20 g of core-shell particle was dipped into 20 ml of water to measure the pH values of the water after dipping the core-shell particle in water for different periods. The pH value was 7 after dipping the core-shell particle for 2 hours, the pH value was 7 after dipping the core-shell particle for 6 hours, the pH value was 8 after dipping the core-shell particle for 22 hours, and the pH value was 9 after dipping the core-shell particle for 26 hours. Obviously, the core-shell particle was less prone to be hydrolyzed compared to the aluminum nitride powder without being wrapped in a shell.

100 g of the described core-shell particle was put into a mold, and then pressed and heated to 1790° ° C. for being sintered for 4 hours to form a ceramic bulk with a thermal conductivity of 171 W/m·K. The above steps were repeated, and the difference was heated to 1810° C. for being sintered for 4 hours to form a ceramic bulk with a thermal conductivity of 175 W/m·K. Obviously, the ceramic bulk formed by sintering the core-shell particle at the same temperature had a higher thermal conductivity compared to the ceramic bulk formed by sintering the aluminum nitride powder without being wrapped in a shell.

### Comparative Example 2 (AlN/(Al:Y=80.3:19.7), Too Much Y)

Aluminum nitride powder (with a particle size of 500 nm to 2500 nm) was put into a reaction chamber, and then heated to 375° C. In addition, several steel cylinders containing metal acetylacetonate compound powders such as Al(acac)₃ and Y(acac)₃ were heated to 400° C. to form metal acetylacetonate compound vapors. Nitrogen of different flow rates was introduced to the metal acetylacetonate compound vapors, respectively, and then introduced to the reaction chamber, thereby controlling the ratio of aluminum acetylacetonate compound vapor to yttrium acetylacetonate compound vapor conducted into the reaction chamber. The nitrogen introduced into the aluminum acetylacetonate compound vapor had a flow rate of 0.025 L/min and the nitrogen introduced into the yttrium acetylacetonate compound vapor had a flow rate of 0.1 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 385° C. As such, the acetylacetonate molecule was gradually decomposed to leave an yttrium-doped aluminum shell (with a thickness of 8 nm to 15 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited yttrium-doped aluminum shell) contained 80.3 wt % of aluminum and 19.7 wt % of yttrium. In the above core-shell particle, the core and the shell had a weight ratio of 94.5:5.5.

20 g of core-shell particle was dipped into 20 mL of water to measure the pH values of the water after dipping the core-shell particle in water for different periods. The pH value was 7 after dipping the core-shell particle for 2 hours, the pH value was 7 after dipping the core-shell particle for 6 hours, the pH value was 8 after dipping the core-shell particle for 22 hours, and the pH value was 9 after dipping the core-shell particle for 26 hours. Obviously, the core-shell particle was less prone to be hydrolyzed compared to the aluminum nitride powder without being wrapped in a shell.

100 g of the described core-shell particle was put into a mold, and then pressed and heated to 1790° ° C. for being sintered for 4 hours to form a ceramic bulk with a thermal conductivity of 124 W/m·K. The above steps were repeated, and the difference was heated to 1810° C. for being sintered for 4 hours to form a ceramic bulk with a thermal conductivity of 141 W/m·K. Obviously, if the shell of the core-shell particle included too much yttrium, the ceramic bulk formed by sintering the core-shell particle at the same temperature would have a lower thermal conductivity.

### Comparative Example 3 (AlN/(Al:Y=99.1:0.9), Too Thin Shell)

Aluminum nitride powder (with a particle size of 500 nm to 2500 nm) was put into a reaction chamber, and then heated to 345° C. In addition, several steel cylinders containing metal acetylacetonate compound powders such as Al(acac)₃ and Y(acac)₃ were heated to 350° C. to form metal acetylacetonate compound vapors. Nitrogen of different flow rates was introduced to the metal acetylacetonate compound vapors, respectively, and then introduced to the reaction chamber, thereby controlling the ratio of aluminum acetylacetonate compound vapor to yttrium acetylacetonate compound vapor introduced into the reaction chamber. The nitrogen introduced into the aluminum acetylacetonate compound vapor had a flow rate of 0.025 L/min and the nitrogen introduced into the yttrium acetylacetonate compound vapor had a flow rate of 0.025 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 350° C. As such, the acetylacetonate molecule was gradually decomposed to leave an yttrium-doped aluminum shell (with a thickness of 1 nm to 3 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited yttrium-doped aluminum shell) contained 99.1 wt % of aluminum and 0.9 wt % of yttrium. In the above core-shell particle, the core and the shell had a weight ratio of 99.2:0.8.

20 g of core-shell particle was dipped into 20 mL of water to measure the pH values of the water after dipping the core-shell particle in water for different periods. The pH value was 7 after dipping the core-shell particle for 2 hours, the pH value was 9 after dipping the core-shell particle for 6 hours, the pH value was 10 after dipping the core-shell particle for 22 hours, and the pH value was 11 after dipping the core-shell particle for 26 hours. Obviously, the core-shell particle with the overly thin shell had a poor resistance to hydrolysis.

100 g of the described core-shell particle was put into a mold, and then pressed and heated to 1790° ° C. for being sintered for 4 hours to form a ceramic bulk with a thermal conductivity of 89 W/m·K. The above steps were repeated, and the difference was heated to 1810° C. for being sintered for 4 hours to form a ceramic bulk with a thermal conductivity of 101 W/m·K. Obviously, if the shell of the core-shell particle was too thin, the ceramic bulk formed by sintering the core-shell particle at the same temperature would have a lower thermal conductivity.

### Comparative Example 4 (AlN/(Al:Y=99.2:0.8), Too Thick Shell)

Aluminum nitride powder (with a particle size of 500 nm to 2500 nm) was put into a reaction chamber, and then heated to 385° C. In addition, several steel cylinders containing metal acetylacetonate compound powders such as Al(acac)₃ and Y(acac)₃ were heated to 400° C. to form metal acetylacetonate compound vapors. Nitrogen of different flow rates was conducted to the metal acetylacetonate compound vapors, respectively, and then conducted to the reaction chamber, thereby controlling the ratio of aluminum acetylacetonate compound vapor to yttrium acetylacetonate compound vapor introduced into the reaction chamber. The nitrogen introduced into the aluminum acetylacetonate compound vapor had a flow rate of 0.2 L/min and the nitrogen introduced into the yttrium acetylacetonate compound vapor had a flow rate of 0.05 L/min. Because the aluminum nitride powder was heated and the mixture gas of the nitrogen and the metal acetylacetonate compound vapors were introduced into the reaction chamber, the aluminum nitride was in a fluid state. As such, the aluminum nitride could be evenly mixed with and in contact with the metal acetylacetonate compound vapors. The metal acetylacetonate compound vapors were mixed and then deposited onto the surface of the aluminum nitride powder, thereby forming a metal acetylacetonate compound film on the surface of the aluminum nitride powder. When the metal acetylacetonate compound film achieved the desired thickness, introducing the mixture gas of nitrogen and the metal acetylacetonate compound vapors into the reaction chamber was stopped, and the temperature of the aluminum nitride powder wrapped in the metal acetylacetonate compound film was kept at 350° C. As such, the acetylacetonate molecule was gradually decomposed to leave an yttrium-doped aluminum shell (with a thickness of 121 nm) to wrap the aluminum nitride powder. In the elemental analysis results of the described core-shell particle, the core (from aluminum nitride powder) contained 32.77 wt % of nitrogen, 2.58 wt % of oxygen, and 64.65 wt % of aluminum; and the shell (from the deposited yttrium-doped aluminum shell) contained 99.2 wt % of aluminum and 0.8 wt % of yttrium. In the above core-shell particle, the core and the shell had a weight ratio of 88.0:12.0.

20 g of core-shell particle was dipped into 20 mL of water to measure the pH values of the water after dipping the core-shell particle in water for different periods. The pH value was 7 after dipping the core-shell particle for 2 hours, the pH value was 7 after dipping the core-shell particle for 6 hours, the pH value was 7 after dipping the core-shell particle for 22 hours, and the pH value was 8 after dipping the core-shell particle for 26 hours.

100 g of the described core-shell particle was put into a mold, and then pressed and heated to 1790° C. for being sintered for 4 hours to form a ceramic bulk with a thermal conductivity of 56 W/m·K. The above steps were repeated, and the difference was heated to 1810° C. for being sintered for 4 hours to form a ceramic bulk with a thermal conductivity of 48 W/m·K. Obviously, if the shell of the core-shell particle was too thick, the ceramic bulk formed by sintering the core-shell particle at the same temperature would have a lower thermal conductivity.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A core-shell particle, comprising:
a core including aluminum nitride; and
a shell wrapped around the core,
wherein the shell includes aluminum and a dopant, and the dopant is yttrium, calcium, magnesium, lanthanum, niobium, titanium, copper, or a combination thereof.

2. The core-shell particle as claimed in claim 1, wherein the core and the shell have a weight ratio of 90:10 to 99:1.

3. The core-shell particle as claimed in claim 1, wherein the core and the shell have a weight ratio of 95:5 to 98:2.

4. The core-shell particle as claimed in claim 1, wherein aluminum and the dopant in the shell have a weight ratio of 90:10 to 99.9:0.1.

5. The core-shell particle as claimed in claim 1, wherein aluminum and the dopant in the shell have a weight ratio of 95:5 to 99.5:0.5.

6. The core-shell particle as claimed in claim 1, wherein the shell has a thickness of 5 nm to 100 nm.

7. The core-shell particle as claimed in claim 1, wherein the core has a particle size of 300 nm to 3000 nm.

8. A ceramic bulk, being formed by sintering the core-shell particle as claimed in claim 1.
